(19) United States
(12) Patent Application Publication
(10) Pub. No.: US 2019/0087741 A1
(43) Pub. Date: Mar. 21, 2019

(54) METHOD FOR DYNAMICALLY SELECTING OPTIMAL MODEL BY THREE-LAYER ASSOCIATION FOR LARGE DATA VOLUME PREDICTION

(71) Applicant: NANJING HOWSO TECHNOLOGY CO., LTD, Jiangsu (CN)

(72) Inventors: Donghua WU, Jiangsu (CN); Mantian HU, Jiangsu (CN); Xingxiu YAN, Jiangsu (CN)

(73) Assignee: NANJING HOWSO TECHNOLOGY CO., LTD, Jiangsu (CN)

(21) Appl. No.: 16/085,315

(22) PCT Filed: May 10, 2016
(86) PCT No.: PCT/CN2016/081481

§ 371 Date: Sep. 14, 2018

(30) Foreign Application Priority Data
Mar. 23, 2016 (CN) 201610168473.1
Mar. 30, 2016 (CN) 201610192864.7

(51) Int. Cl. G06N 7/00; G06N 20/10; G06F 17/18; G06N 20/20; G06F 17/15

(52) U.S. Cl. CPC G06N 7/00; G06N 20/10; G06F 17/15; G06N 20/20; G06F 17/18

(57) ABSTRACT

A method for dynamically selecting an optimal model by three-layer correlation for predicting a large amount of data is provided, which includes a prediction model algorithm library, a weightage algorithm library and an ensemble learning algorithm with optimal weightage. The prediction model algorithm library comprises multiple prediction model algorithms which are called a common interface at the lowest layer of the correlation algorithm, to provide a prediction function and a support function for upper layers. The weightage algorithm library covers a diversity of underlying algorithms of the prediction algorithm library, and selects and combines the underlying algorithms with multiple methods based on prediction results from the underlying algorithms to form multiple weightage algorithms. The ensemble learning algorithm with optimal weightage is used to select an optimal weightage algorithm for prediction based on evaluation of the weightage algorithm on a validation set.

### FIELD

The present disclosure relates to a method for dynamically selecting an optimal model by three-layer correlation for predicting a large amount of data.

### BACKGROUND

Nowadays, up to 250 trillion bytes data is generated every day, which is more than 90% of data volume generated in the past two years. The large amount of data is stored in computers in a structured form. Storing the structured data is well organized, but the logical correlation between the structured data is destroyed. For example, two adjacent cells in communication networks impact the performance of each other with a mutual-causal process following a certain mode over time. And what is stored in the computer is just two series of data without correlation and pattern recognition. In practice, lots of series of such data are stored, which makes the correlation and the pattern become more complicated. In such a large amount of complicated data, a stable and accurate model is requested to find the correlation and capture the pattern to make a prediction, which causes higher requirements for conventional algorithms.

In order to obtain such an ideal model, analyzing a conventional modeling process becomes a need. When a prediction is performed based on a large amount of data, statistical methods along with visualization thereof may be first used to study characteristics of the data, such as linearity or non-linearity, a period, a lag, a type of distribution and so on. If significant characteristics have not been presented, data transformation is applied to the data, then characteristics of the transformed data are analyzed with statistics and visualization methods until the significant mathematical characteristics are found, and then modeling is performed based on the mathematical characteristics. This modeling process is normally working for most use cases. However, such modeling process may cause problems for some cases.

The first problem is that a wrong model may be selected. It is assumed that a series of data is generated that presents mathematical characteristics of oscillations period becoming shorter gradually (assuming that it is a sine with a period becoming shorter gradually), and that the series of data has a very long period so that the sine wave presents linear in a certain time, but a different pattern may occur in a long term. In a certain time, its pattern may be captured incorrectly. In practical application, if the amount of data is not sufficient, the selected model based on the data mining may be biased. And also, once a certain model is locked down in training and testing phase, it normally will not be changed in the production environment even if more data is collected or a low prediction rate occurs. The prediction rate may become lower as more data are collected.

A second problem lies in that it is required to customize a model for each targeted data series in terms of different series for making prediction. The customization of models will consume a lot of time and the above biased model cannot be avoided. It is desirable to develop each model simply and scientifically, to achieve a stable and relative accurate prediction rate.

A third problem lies in a difficulty of rapid dynamic prediction. When another targeted data series is requested for prediction, the modeling process includes: analysis, modeling and evaluation. Apparently, this does not satisfy the rapid dynamic prediction. It is expected that an existing model is selected intelligently for performing a prediction for the targeted series of data, like other data that has corresponding models, which can ensure the accuracy of the prediction rate.

### SUMMARY

In order to address the above issues, specific analysis is performed for addressing the three issues according to the present disclosure, and some common spaces are found. In case of a large amount of data, higher errors often occur between predicted values and observed values, and prediction window becomes lengthier. In order to avoid higher errors, a method for dynamically selecting an optimal model by three-layer correlation for predicting a large amount of data is provided according to the present disclosure. In a prediction step, the most appropriate model may be dynamically selected and a model with poor prediction rate may be discarded. In this way, a stability of prediction is guaranteed, and the error is controlled within a reasonable range.

The technical solution of the present disclosure is described as follows.

A method for dynamically selecting an optimal model by three-layer correlation for predicting a large amount of data is provided. A three-layer correlation algorithm involves three layers of a prediction model algorithm library, a weightage algorithm library and an ensemble learning algorithm with optimal weightage. The prediction model algorithm library stays at a lowest layer, the weightage algorithm library stays above the prediction model algorithm library, and the ensemble learning algorithm with optimal weightage stays above the weightage algorithm library.

The prediction model algorithm library includes multiple prediction model algorithms which are called a common interface at the lowest layer of the correlation algorithm, to provide a prediction function and a support function for upper layers.

The weightage algorithm library covers a diversity of underlying algorithms of the prediction algorithm library, and selects and combines the underlying algorithms with multiple methods based on prediction results from the underlying algorithms to form multiple weightage algorithms.

The weightage algorithm library covers a diversity of underlying algorithms of the prediction algorithm library, and selects and combines the underlying algorithms with multiple methods based on prediction results from the underlying algorithms to form multiple weightage algorithms.

The ensemble learning algorithm with optimal weightage is used to select an optimal weightage algorithm for prediction based on evaluation of the weightage algorithm on a validation set.

The prediction model algorithm library is implemented by the following steps:

inputting training data;

preprocessing the training data to obtain data to be used after; and

performing model fitting by using two or more different algorithms on the data to be used, to obtain models to be selected.

The preprocessing the training data includes:

data determining: removing excessive sparse data series;

processing of a time format: mapping time series to consecutive integers; and

data complement: performing interpolation on missing data or error data.

The weightage algorithm includes:

a first algorithm, in which a same weightage is assigned to all the prediction models;

a second algorithm, in which 20% of the prediction models with poor prediction results are discarded, and a same weightage is assigned to the remaining prediction models;

a third algorithm, in which a Root-Mean-Square Error for each prediction model is calculated, based on which a reversed function is built, and a weightage is assigned to each prediction model based on the function;

a fourth algorithm, in which a minimal absolute error for each prediction model is calculated, based on which a reversed function is built, and a weightage is assigned to each prediction model based on the function;

a principle of algorithm 6) is similar to the algorithm 3), except the calculation of an Akaike Information Criterion (AIC); and based on AIC, a reversed function is built, and a weightage is assigned to;

a fifth algorithm, in which a least square error for each prediction model is calculated, based on which a reversed function is built, and a weightage is assigned to each prediction model based on the function; and

a sixth algorithm, in which an Akaike Information Criterion (AIC) for each prediction model is calculated, based on which a reversed function is built, and a weightage is assigned to each prediction model based on the function.

The prediction model algorithm library is implemented by the following steps:

calling a prediction model library to obtain a predicted data set for a prediction model;

calling each weightage algorithm and calculating weightages; and

assigning a corresponding weightage to each prediction model, performing a data prediction and storing predicted data.

An optimal weightage algorithm is selected based on a prediction quality on a testing set for each weightage algorithm, and the ensemble learning algorithm with optimal weightage is implemented by the following steps:

calling an algorithm of the weightage algorithm library to obtain a data set of weightage prediction;

comparing the data set of weightage library prediction with the validation set to obtain errors;

obtaining the optimal weightage algorithm based on a minimal error; and

storing predicted data obtained from the optimal weightage algorithm to obtain the prediction results.

Advantages of the present disclosure are as follows. In a method for dynamically selecting an optimal model by three-layer correlation for predicting a large amount of data provided according to the present disclosure, a three-layer structure is characterized by four characteristics of high accountability, prediction stability, dynamic adjustment of the model, and universality of the model for predicting data. This application uses the correlation algorithm. The correlation algorithm avoids some disadvantages of existing algorithms. Multiple algorithms are combined by assigning the algorithms with different weightages, that is, a high-applicability algorithm is assigned with a high weightage, and a low-applicability algorithm is assigned with a low weightage, which ensures the accuracy of the data prediction and the stability of prediction in spite of increasing amount of data.

### BRIEF DESCRIPTION OF THE DRAWINGS

FIG. 1 is a schematic diagram of a method for dynamically selecting an optimal model by three-layer correlation for making prediction for a large amount of data according to an embodiment of the present disclosure.

FIG. 2 is a schematic diagram of a hybrid error rate of KPI of an ARIMA algorithm in the embodiment.

FIG. 3 is a schematic diagram of an error rate of a Holtwinters algorithm under KPI in the embodiment.

FIG. 4 is a schematic diagram of an error rate of an Arima algorithm under KPI in the embodiment.

### DETAILED DESCRIPTION OF EMBODIMENTS

A preferred embodiment of the present disclosure is described in detail in conjunction with drawings hereinafter.

For a KPI prediction for cells, predicted data should be accurate and stable. However, a desired result cannot be obtained in a practical application. This is because general algorithms have certain limitation and applicability, which causes a poor prediction for some data. In this case, a correlation algorithm is used in the embodiment to avoid disadvantages of general algorithms. Multiple algorithms are combined by assigning the algorithms with different weightages, that is, a high-applicability algorithm is assigned with a high weightage, and a low-applicability algorithm is assigned with a low weightage, to ensure the accuracy of prediction and also the stability of prediction in spite of the increasing amount of data. The correlation algorithm is applied to the experiment to achieve better stability and accuracy.

Embodiment

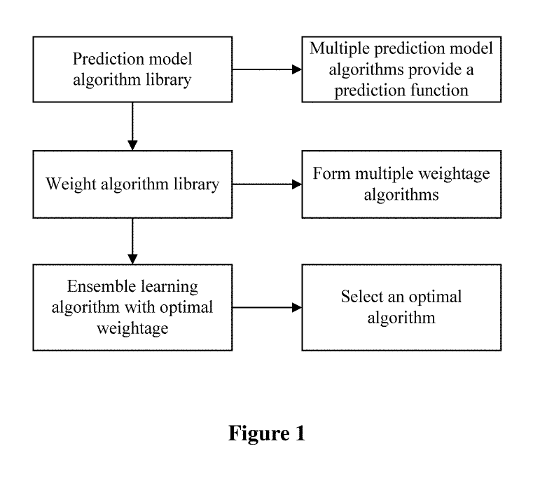

Reference is made to FIG. 1, which illustrates a method for dynamically selecting an optimal model by three-layer correlation for making prediction for a large amount of data. The three-layer algorithm involve: a prediction model algorithm library, a weightage algorithm library, and an ensemble learning algorithm with optimal weightage.

The prediction model algorithm library includes a variety of classic algorithms, improved classical algorithms and some patented algorithms. These algorithms are called a common interface. These algorithms stay at a lowest layer of the correlation algorithm to provide a prediction function and a support function for upper layers.

The weightage algorithm stays above the prediction model algorithm library. The weightage algorithm packages the prediction model algorithm library and covers a diversity of underlying algorithms. It does not request a user to consider parameters, periods, convergences and errors of the various underlying algorithms. Based on prediction results from the underlying algorithms, the underlying algorithms are selected and combined with various methods (such as, averaging prediction results from all the underlying algorithms, discarding some of the worst prediction results, assigning with weightage in terms of results from RMSE, assigning with weightage in terms of results from OLS, assigning with weightage in terms of results from AIC, and assigning with weightage in terms of results from LAD) to form multiple weightage algorithms.

The multiple weightage algorithms are used to calculate different weightages while using different mathematical characteristics. These differences derive from characteristics of the predicted data and a selected weightage formula. These weightage algorithms fit different data. There is a need to determine which weightage algorithm should be selected based on the evaluation on a validation set. An algorithm is desired to automatically determine the weightage algorithm, which is a third layer of the correlation algorithm, i.e., an ensemble learning algorithm with optimal weightage. The third-layer algorithm is a package for the weightage algorithms. Based on evaluation of the weightage algorithms on the validation set, the optimal weightage algorithm is selected to perform prediction.

In the method for dynamically selecting an optimal model by three-layer correlation for predicting a large amount of data, the three-layer structure has four characteristics: high accountability, prediction stability, dynamic adjustment of the model, and universality of the model for predicting data. This algorithm also has a disadvantage, i.e., low efficiency. Considering the rapid development of performances of computer hardware and software, and the rapid growth of distribution technology, the disadvantage becomes unimportant compared with the above four characteristics.

In the method for dynamically selecting an optimal model by three-layer correlation for predicting a large amount of data, the prediction model algorithm library at the lowest layer includes a variety of classical algorithms, improved classical algorithms and some patented algorithms. These algorithms include ar, mr, arma, holtwinters, var, svar, svec, garch, svm and fourier. These algorithms are respectively applicable for different predictions of data. For example, arma, arima, var, svar and svec algorithms may be applied for stationary series, or for non-stationary series which should suffer to stationary processing first. Other algorithms may be applied for the non-stationary series. The svm algorithm may be applied for high-dimension data. The var algorithm may be applied for multi-time series. The garch model has an advantage for a long-time prediction. Each algorithm involves multiple parameters. For example, the arima algorithm involves parameters p, d and q, which may be given different values. Each algorithm may also have many variants. For example, svar and svec algorithms are respective variants of var algorithm, and garch algorithm is an expansion of arch algorithm in use scope. Different algorithms require different input data formats. For an algorithm predicted results on a training set has different from that on a testing set. For example, the boundary of a first cycle for the training set of HOLT-WINTERS algorithm is unpredictable, while it is predictable for ARIMA algorithm. Furthermore, some models are trained for multiple cycles, such as VAR, requiring a special processing.

Since the common interface should be provided for its upper layer, all the above-mentioned differences have to be covered. In particular, if a module involves multiple parameters, separate models are set based on each of parameters, and separate models are also set for the variants. For example, there are 32 combinations of parameters p, d and q of the arima model, 32 models may be set, for example, arima (1,1,0) and arima (2,1,0) are two models. In addition, models are also separately set for the variants, for example, the var and the svec are variants of the same model type, and are separately set as two modules. For a model with an unpredictable boundary, boundary values are not taken into consideration during the calculation of errors. For example, a prediction value of the first cycle for the training set of HOLT-WINTERS model does not exist, thus this error is not considered for an overall error. It is evaluated that this error that is not considered has few effect on a practical prediction. The model is trained for one by one cycle to predict data, and the predicted data is combined into an array in chronological order. For example, for a VAR model, a value of the VAR on a multi-cycle prediction is a matrix, and values successively in rows of the matrix are stored as an array. In this way, the values in the array are exactly sorted by time, which are unified with the prediction results obtained with other prediction methods, which is convenient for comparison.

Above the prediction model algorithm library is the weightage algorithm library. The weightage algorithm library includes optimal models. The “optimal” is difficult to determine. An optimal performance on the validation set may possibly not present the same for more data series, such as the over-fitting model, which presents well on the validation set, but not on the prediction set. Therefore, six weightage algorithms are used in the weightage algorithm library, as described in the summary.

The six weightage algorithms select and combine the results in the prediction algorithm model library to derive six algorithms based on the respective principles. The six algorithms have different primary characteristics from each other, to attempt to capture more data characteristics and extend the data characteristics to the prediction set. Even if the data characteristics cannot be extended to the prediction set, the parameters can also be adjusted dynamically to reduce impacts of “bad” models to increase the accuracy of prediction.

The six weightage algorithms are described as follows.

1) A same weightage is assigned to all the prediction models, where the weightage w=1/n, n being the number of prediction models.

2) All errors (e₁, e₂ . . . , eₙ) on the prediction models are sorted to determine 80% of prediction models with small errors, to which a same weightage W_{new} is assigned, where W_{new}=1/m, in being the number of the determined prediction models.

3) Root-Mean-Square Error (RMSE) for each prediction model is calculated, based on which a reversed function is built, and a weightage is assigned to each prediction model based on the reversed function:

$$w = g ( f ( {e}_{1} , {e}_{2} , , {e}_{n} ) ) , {e}_{i} = error\_value ;$$

$$f \text{\textasciitilde} f ( \frac{1}{rmse ( {x}_{1} , {x}_{2} , , {x}_{n} ; {y}_{1} , {y}_{2} , , {y}_{n} , )} ) , \\ {x}_{i} = forecast\_value , {y}_{i} = observation\_value ;$$

$$g = g ( {x}_{1} , {x}_{2} , , {x}_{n} ) = ( \frac{{x}_{1}}{{\sum }_{1}^{n} {x}_{i}} , \frac{{x}_{2}}{{\sum }_{1}^{n} {x}_{i}} , , \frac{{x}_{n}}{{\sum }_{1}^{n} {x}_{i}} )$$

$$rmse = \sqrt[ ]{{\sum }_{1}^{n} {( {x}_{i} - {y}_{i} )}^{2}} , {x}_{i} = forecast\_value , {y}_{i} = observation\_value ,$$

in the above equation, eᵢ represents the error of the i-th prediction model, xᵢ represents a prediction value of the i-th variable, yᵢ represents an observation value of the i-th variable, and g defines a reversed function in the formula.

A principle of algorithm 4) is similar to that of the algorithm 3), except the calculation of a minimal absolute error.

A principle of algorithm 5) is similar to that of the algorithm 3), except the calculation of least square error.

A principle of algorithm 6) is similar to the algorithm 3), except the calculation of an Akaike Information Criterion (AIC). Based on AIC, a reversed function is built, and a weightage is assigned to.

Specific steps to implement the prediction model algorithm library are described as follows:

inputting training data; and

outputting predicted data of the weightage model library.

The prediction model library is called to obtain a predicted data set of the prediction model, data_fest.

The weightage algorithm i is called to calculate the weightage, i being an integer ranging from 1 to the number of weightage algorithms.

A corresponding weightage is assigned to each prediction model for data prediction and the predicted data is stored.

The top layer is the ensemble learning algorithm with optimal weightage. The ensemble learning algorithm with optimal weightage selects the optimal weightage algorithm from the six weightage algorithms. The selection is based on the prediction rates of the six weightage algorithms on the testing set.

Specific steps to implement the ensemble learning algorithm with optimal weightage are described as follows:

inputting training data; and

outputting predicted data.

1) Algorithms of the weightage algorithm library are called to obtain a data set of weightage prediction.

2) The data set of weightage library prediction is compared with the validation set to obtain errors.

3) The optimal weightage algorithm is obtained based on a minimal error.

4) Predicted data obtained from the optimal weightage algorithm are stored to obtain the prediction results.

Steps of predicting data under multiple data series (CELL) for multiple KPIs are described as follows:

inputting training data; and

outputting predicted data.

An ensemble learning algorithm with optimal weightage is called for each data series of each KPI to obtain the predicted data, which is then stored.

Experimental Verification

In order to evaluate the quality of the correlation algorithm, 12 KPI data of 1500 cells are selected for an experiment to obtain comparison results in accuracy and stability between the correlation algorithm and general algorithms.

Steps of the experiment is described as follows.

First, data are collected and processed, and an algorithm model is established in a three-layer structure. The correlation algorithm and the general algorithm are used to predict data. Corresponding prediction results are obtained.

Then, the quality of the correlation algorithm model is evaluated hybridly by comparing the accuracy and stability of predicted data on the correlation algorithm model and the general model.

The experiment includes two parts. In the first part, the general model is trained on the training data for prediction to obtain an error, and the correlation algorithm model is trained on the training data for prediction to obtain an error. In the second part, the quality of the correlation algorithm is evaluated by comparing the errors obtained by training on the training sets of the correlation algorithm model and the general model.

Experiment Data

First, data is collected every half an hour for 121 days, e.g., from Jul. 29, 2014 to Nov. 26, 2014, totally 5808 pieces of data. Such collection involves 6 uplink KPIs in 1500 cells and 6 downlink KPIs in the 1500 cells.

To validate the integrity of the data, interpolation is applied to handle missing and error values. And if there are too many NaN and the missing values in a cell, the data in the cell is removed.

Experiment Method

First, the general model is trained on the training data for prediction, and predicted data and an error from the general model are stored. Then, the correlation algorithm model is trained on the training data for prediction, and predicted data and an error are stored. Finally, the prediction quality of the correlation algorithm and that of the general model are compared, where a prediction error on the training set, a prediction error on the prediction set and a difference between the prediction error on the training set and that on the prediction set for the general model and the correlation algorithm are calculated. Weightages of 0.3, 0.3 and 0.4 are respectively assigned to the prediction error on the training set, the prediction error on the prediction set and the difference between the prediction error on the training set and that on the prediction set, to finally obtain a hybrid error value.

Experiment Result

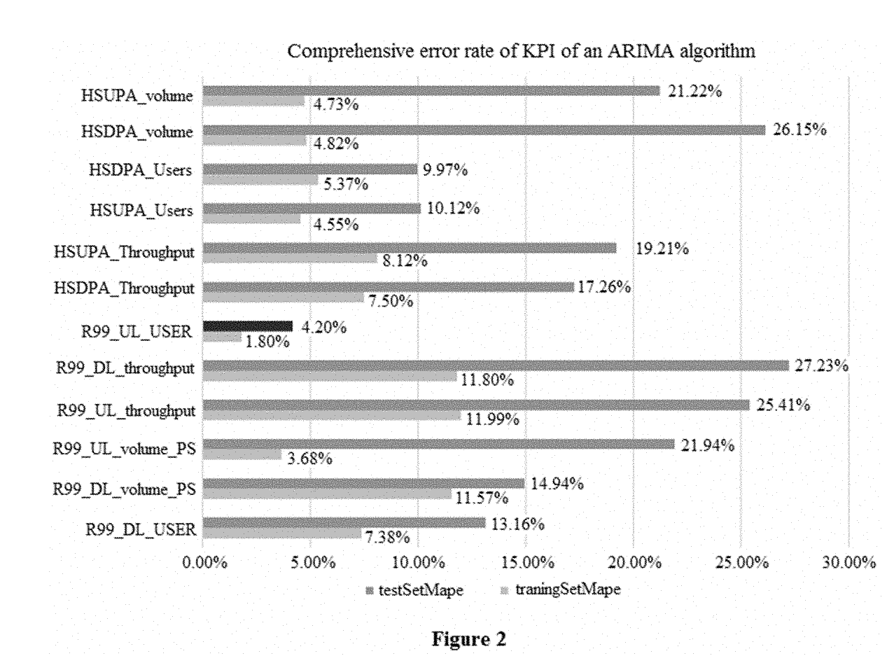

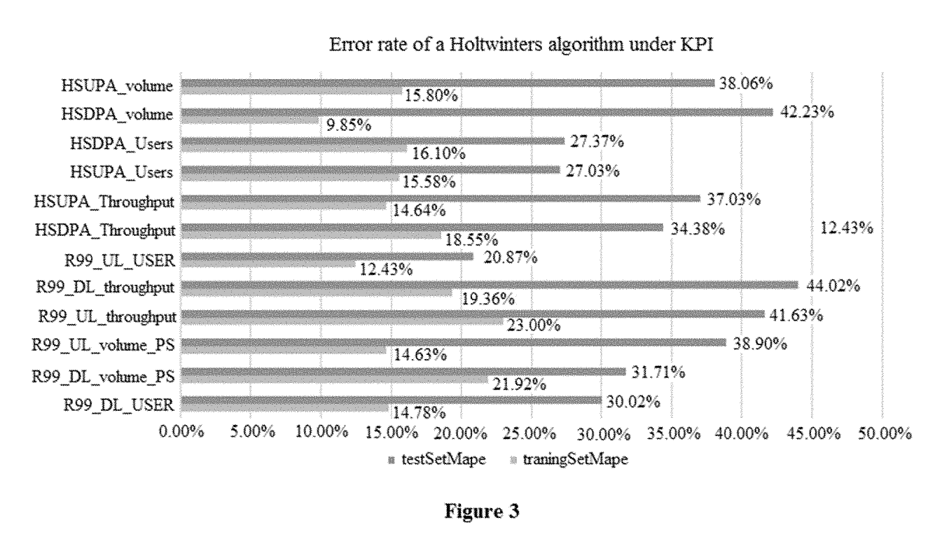

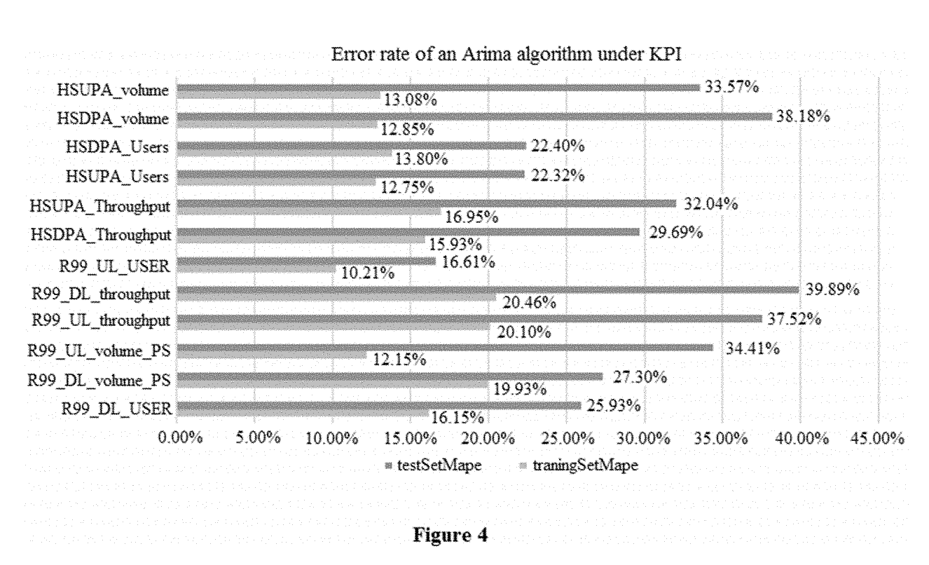

By comparison of the prediction quality of the correlation algorithm and the general algorithm, the prediction errors on the training set and the prediction error on the testing set for 12 KPIs in 1500 cells are obtained (as shown in FIGS. 2, 3 and 4). FIG. 2 is a schematic diagram of a hybrid error rate of KPI of an ARIMA algorithm in the embodiment. FIG. 3 is a schematic diagram of an error rate of a Holtwinters algorithm under KPI in the embodiment. FIG. 4 is a schematic diagram of an error rate of an Arima algorithm under KPI in the embodiment.

The data in FIGS. 2, 3 and 4 shows that, the error on the training set and the error on the prediction set for the correlation algorithm are increased respectively by 9% and 13% in relative to the general algorithm. The hybrid error value is increased by about 12%.

1. A method for dynamically selecting an optimal model by three-layer correlation for predicting a large amount of data, wherein
a three-layer correlation algorithm involves three layers of a prediction model algorithm library, a weightage algorithm library and an ensemble learning algorithm with optimal weightage,
the prediction model algorithm library stays at a lowest layer, the weightage algorithm library stays above the prediction model algorithm library, the ensemble learning algorithm with optimal weightage stays above the weightage algorithm library,
the prediction model algorithm library comprises multiple prediction model algorithms which are called a common interface at the lowest layer of the correlation algorithm, to provide a prediction function and a support function for upper layers,
the weightage algorithm library covers a diversity of underlying algorithms of the prediction algorithm library, and selects and combines the underlying algorithms with multiple methods based on prediction results from the underlying algorithms to form multiple weightage algorithms, and
the ensemble learning algorithm with optimal weightage is used to select an optimal weightage algorithm for prediction based on evaluation of the weightage algorithm on a validation set.

2. The method for dynamically selecting an optimal model by three-layer correlation for predicting a large amount of data according to claim 1, wherein the prediction model algorithm library is implemented by the following steps:
inputting training data;
preprocessing the training data to obtain data to be used after; and
performing model fitting by using two or more different algorithms on the data to be used, to obtain models to be selected.

3. The method for dynamically selecting an optimal model by three-layer correlation for predicting a large amount of data according to claim 2, wherein the preprocessing the training data comprises:
data determining: removing excessive sparse data series;
processing of a time format: mapping time series to consecutive integers; and
data complement: performing interpolation on missing data or error data.

4. The method for dynamically selecting an optimal model by three-layer correlation for predicting a large amount of data according to claim 1, wherein the weightage algorithm comprises:
a first algorithm, in which a same weightage is assigned to all the prediction models;
a second algorithm, in which 20% of the prediction models with poor prediction results are discarded, and a same weightage is assigned to the remaining prediction models;
a third algorithm, in which a Root-Mean-Square Error for each prediction model is calculated, based on which a reversed function is built, and a weightage is assigned to each prediction model based on the function;
a fourth algorithm, in which a minimal absolute error for each prediction model is calculated, based on which a reversed function is built, and a weightage is assigned to each prediction model based on the function;
a principle of algorithm 6) is similar to the algorithm 3), except the calculation of an Akaike Information Criterion (AIC); and based on AIC, a reversed function is built, and a weightage is assigned to;
a fifth algorithm, in which a least square error for each prediction model is calculated, based on which a reversed function is built, and a weightage is assigned to each prediction model based on the function; and
a sixth algorithm, in which an Akaike Information Criterion (AIC) for each prediction model is calculated, based on which a reversed function is built, and a weightage is assigned to each prediction model based on the function.

5. The method for dynamically selecting an optimal model by three-layer correlation for predicting a large amount of data according to claim 1, wherein the prediction model algorithm library is implemented by the following steps:
calling a prediction model library to obtain a predicted data set for a prediction model;
calling each weightage algorithm and calculating weightages; and
assigning a corresponding weightage to each prediction model, performing a data prediction and storing predicted data.

6. The method for dynamically selecting an optimal model by three-layer correlation for predicting a large amount of data according to claim 1, wherein an optimal weightage algorithm is selected based on a prediction quality on a testing set for each weightage algorithm, and the ensemble learning algorithm with optimal weightage is implemented by the following steps:
calling an algorithm of the weightage algorithm library to obtain a data set of weightage prediction;
comparing the data set of weightage library prediction with the validation set to obtain errors;
obtaining the optimal weightage algorithm based on a minimal error; and
storing predicted data obtained from the optimal weightage algorithm to obtain the prediction results.

7. The method for dynamically selecting an optimal model by three-layer correlation for predicting a large amount of data according to claim 2, wherein the weightage algorithm comprises:
a first algorithm, in which a same weightage is assigned to all the prediction models;
a second algorithm, in which 20% of the prediction models with poor prediction results are discarded, and a same weightage is assigned to the remaining prediction models;
a third algorithm, in which a Root-Mean-Square Error for each prediction model is calculated, based on which a reversed function is built, and a weightage is assigned to each prediction model based on the function;
a fourth algorithm, in which a minimal absolute error for each prediction model is calculated, based on which a reversed function is built, and a weightage is assigned to each prediction model based on the function;
a principle of algorithm 6) is similar to the algorithm 3), except the calculation of an Akaike Information Criterion (AIC); and based on AIC, a reversed function is built, and a weightage is assigned to;
a fifth algorithm, in which a least square error for each prediction model is calculated, based on which a reversed function is built, and a weightage is assigned to each prediction model based on the function; and
a sixth algorithm, in which an Akaike Information Criterion (AIC) for each prediction model is calculated, based on which a reversed function is built, and a weightage is assigned to each prediction model based on the function.

8. The method for dynamically selecting an optimal model by three-layer correlation for predicting a large amount of data according to claim 3, wherein the weightage algorithm comprises:
a first algorithm, in which a same weightage is assigned to all the prediction models;
a second algorithm, in which 20% of the prediction models with poor prediction results are discarded, and a same weightage is assigned to the remaining prediction models;
a third algorithm, in which a Root-Mean-Square Error for each prediction model is calculated, based on which a reversed function is built, and a weightage is assigned to each prediction model based on the function;
a fourth algorithm, in which a minimal absolute error for each prediction model is calculated, based on which a reversed function is built, and a weightage is assigned to each prediction model based on the function;
a principle of algorithm 6) is similar to the algorithm 3), except the calculation of an Akaike Information Criterion (AIC); and based on AIC, a reversed function is built, and a weightage is assigned to;
a fifth algorithm, in which a least square error for each prediction model is calculated, based on which a reversed function is built, and a weightage is assigned to each prediction model based on the function; and
a sixth algorithm, in which an Akaike Information Criterion (AIC) for each prediction model is calculated, based on which a reversed function is built, and a weightage is assigned to each prediction model based on the function.

9. The method for dynamically selecting an optimal model by three-layer correlation for predicting a large amount of data according to claim 2, wherein the prediction model algorithm library is implemented by the following steps:
calling a prediction model library to obtain a predicted data set for a prediction model;
calling each weightage algorithm and calculating weightages; and
assigning a corresponding weightage to each prediction model, performing a data prediction and storing predicted data.

10. The method for dynamically selecting an optimal model by three-layer correlation for predicting a large amount of data according to claim 3, wherein the prediction model algorithm library is implemented by the following steps:
calling a prediction model library to obtain a predicted data set for a prediction model;
calling each weightage algorithm and calculating weightages; and
assigning a corresponding weightage to each prediction model, performing a data prediction and storing predicted data.

11. The method for dynamically selecting an optimal model by three-layer correlation for predicting a large amount of data according to claim 2, wherein an optimal weightage algorithm is selected based on a prediction quality on a testing set for each weightage algorithm, and the ensemble learning algorithm with optimal weightage is implemented by the following steps:
calling an algorithm of the weightage algorithm library to obtain a data set of weightage prediction;
comparing the data set of weightage library prediction with the validation set to obtain errors;
obtaining the optimal weightage algorithm based on a minimal error; and
storing predicted data obtained from the optimal weightage algorithm to obtain the prediction results.

12. The method for dynamically selecting an optimal model by three-layer correlation for predicting a large amount of data according to claim 3, wherein an optimal weightage algorithm is selected based on a prediction quality on a testing set for each weightage algorithm, and the ensemble learning algorithm with optimal weightage is implemented by the following steps:
calling an algorithm of the weightage algorithm library to obtain a data set of weightage prediction;
comparing the data set of weightage library prediction with the validation set to obtain errors;
obtaining the optimal weightage algorithm based on a minimal error; and
storing predicted data obtained from the optimal weightage algorithm to obtain the prediction results.
